(19) United States
(12) Patent Application Publication
(10) Pub. No.: US 2009/0260998 A1
(43) Pub. Date: Oct. 22, 2009

(54) TOILET PLUNGER CLEANING RECEPTACLE

(76) Inventors: Danita C. Davidson, Furnace, OH (US); Jeanine A. Fields, Bidwell, OH (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/309,737

(22) PCT Filed: May 22, 2007
(86) PCT No.: PCT/US2006/019746

§ 371 Date: Jan. 28, 2009

Related U.S. Application Data
(60) Provisional application No. 60/707,544, filed on Aug. 12, 2005.

(51) Int. Cl. B08B 1/00

(52) U.S. Cl. 206/207

(57) ABSTRACT

The receptacle (10) includes a main receptacle tank (12) for receiving a toilet plunger (18) and a volume of sanitizing solution. The bell (20) of the plunger (18) is positioned between a lower brush (26) and an upper brush (24) so that rotation of the plunger handle abrades both the interior and exterior surfaces of the bell (20) against the upper (24) and lower (26) brushes. The tank (12) of the receptacle (10) further receives and holds a sanitizing solution to disinfect the toilet plunger (18). A pair of upper access doors (14, 16) may be provided for allowing the user access to the interior of the tank (12). A drainage hole (30) is formed through a lower surface (40) of the tank (12), allowing for the drainage of used sanitizing solution.

### TECHNICAL FIELD

The present invention relates to janitorial cleaning equipment and household cleaning appliances, and particularly to a toilet plunger cleaning receptacle for sanitizing and cleaning a toilet plunger. In particular, the receptacle includes a main tank for receiving a volume of sanitizing solution, a bell-shaped toilet plunger (“a toilet plunger bell”) and a pair of brushes for providing abrasive cleaning of the bell of the toilet plunger.

### BACKGROUND ART

Toilet brushes and toilet plungers are common household implements that require special sanitary care and cleaning, due to their regular and frequent exposure to fecal matter and other biological waste products. Typical cleaning systems for toilet brushes and toilet plungers only provide minimal disinfection of the toilet implements, generally through the application of a sanitizing solution, and are not effective at removing solid waste products from the implements.

Typical toilet plunger cleaners generally only include means for immersing a toilet plunger in some sort of cleaning solution. No separate brushes, or similar devices, are provided for abrading waste from the plunger is provided. Other common systems are designed merely to retain a plunger and do not provide any means for either sanitizing the plunger or holding other implements, such as a toilet brush. Thus, a multifunctional toilet plunger cleaning receptacle solving the aforementioned problems is desired.

### DISCLOSURE OF INVENTION

This disclosure is directed to a toilet plunger cleaning receptacle with an upper brush and a lower brush. The receptacle has a tank dimensioned and configured for receiving a toilet plunger and a volume of sanitizing solution. The tank has a lower surface and at least one sidewall extending from the lower surface to define an open upper end. At least one door is pivotally mounted on the upper end of the receptacle tank. The door selectively seals the open upper end of the receptacle tank. The door has a plunger hole that is dimensioned and configured to hold the handle of the plunger. The receptacle includes a lower brush disposed within the tank. The lower brush is attached to the lower surface of the receptacle tank. The lower surface of the receptacle tank includes a drainage hole. An upper brush is also disposed within the tank and attached to the sidewall of the receptacle tank. The upper brush is positioned adjacent the lower brush. A faucet extends from the drainage hole for controlling drainage of the sanitizing solution through the drainage hole. In operation, the toilet plunger is inserted into the receptacle tank with the plunger handle projecting through the plunger hole. An interior surface of the toilet plunger bell contacts the lower brush, and an exterior surface of the bell contacts the upper brush. The receptacle is filled with the sanitizing solution in order to clean the bell when the plunger handle is rotated.

The disclosure is also directed to a toilet plunger cleaning receptacle that does not include an upper brush. The toilet plunger cleaning receptacle has a tank that is dimensioned and configured for receiving a toilet plunger and a volume of sanitizing solution. The tank has a lower surface and at least one sidewall extending from the lower surface to define an open upper end. At least one door is pivotally mounted on the upper end of the receptacle tank so that the door selectively seals the open upper end of the receptacle tank. The door has a plunger hole and is configured to receive a handle of the plunger. The toilet plunger cleaning receptacle also includes a lower brush disposed within the tank. The lower brush is attached to the lower surface of the receptacle tank. The lower surface of the receptacle tank includes a drainage hole. A faucet extends from the drainage hole for controlling drainage of the sanitizing solution through the drainage hole. In operation, the toilet plunger is inserted into the receptacle tank with the plunger handle projecting through the plunger hole. An interior surface of the toilet plunger bell contacts the lower brush. The receptacle is filled with the sanitizing solution in order to clean the bell when the plunger handle is rotated.

### BRIEF DESCRIPTION OF THE DRAWINGS

FIG. 1 is a perspective view of a toilet plunger cleaning receptacle according to the present invention, broken away and partially in section to show details of the invention.

FIG. 2 is a section view of the toilet plunger cleaning receptacle according to the present invention, shown in vertical section.

FIG. 3 is a section view of an alternative embodiment of a toilet plunger cleaning receptacle according to the present invention, shown in vertical section.

Similar reference characters denote corresponding features consistently throughout the attached drawings.

### BEST MODES FOR CARRYING OUT THE INVENTION

The present invention provides for a toilet plunger cleaning receptacle. The receptacle receives a sanitizing solution and includes a lower brush mounted to a lower interior surface of the receptacle, and an upper brush mounted to a sidewall of the receptacle, adjacent the lower brush. The receptacle receives a toilet plunger, and the bell of the plunger is positioned between the upper and lower brushes. Rotation of the plunger handle allows for the scrubbing of the plunger bell between the brushes. The receptacle is further designed to receive a separate toilet brush and also to hold a sanitizing solution. Both the plunger and toilet brush are immersed within the sanitizing solution to properly disinfect the toilet implements. The plunger cleaner is provided with a drain for drainage of the used sanitizing solution.

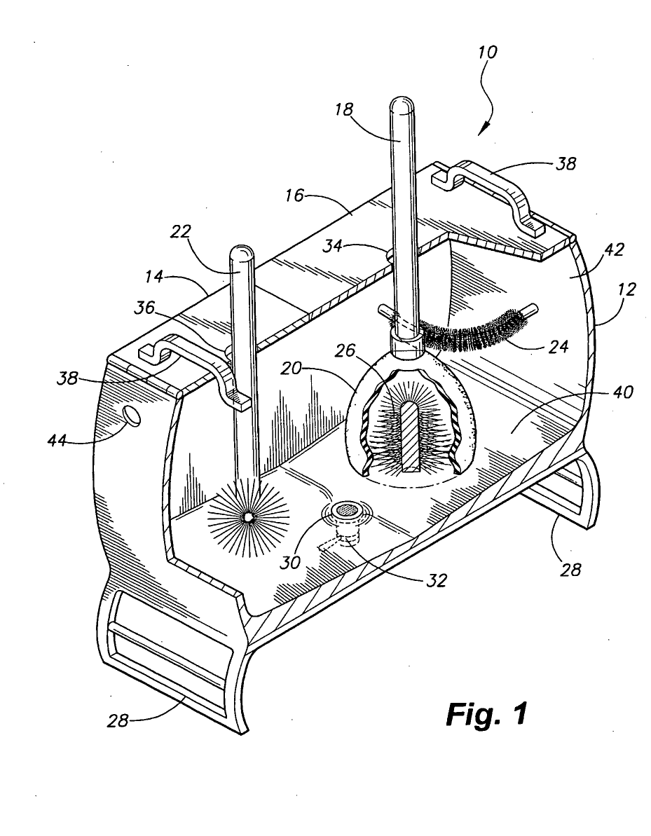

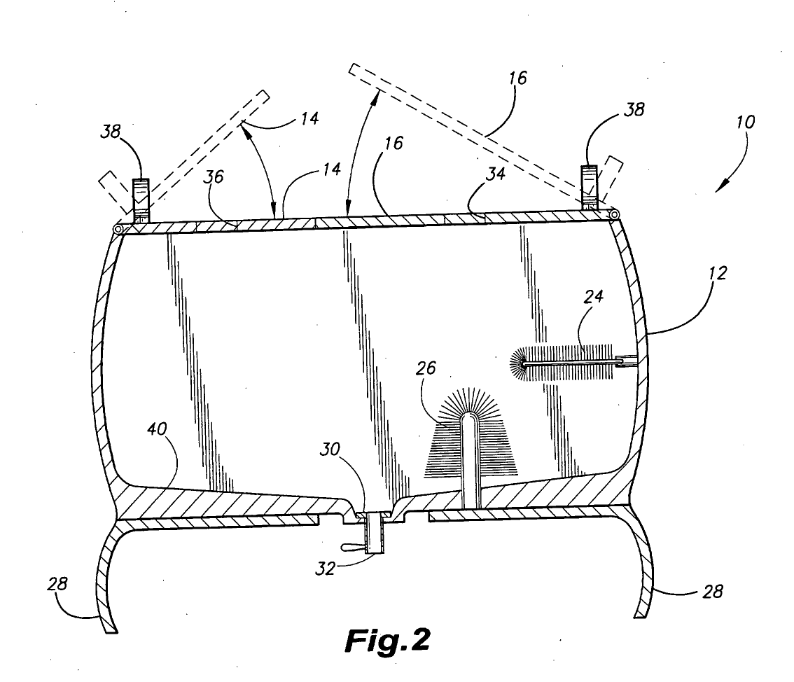

Referring now to FIGS. 1 and 2, there is shown a toilet plunger cleaning receptacle 10 of the present invention. Receptacle 10 includes a main tank 12 for receiving a toilet plunger and a volume of sanitizing solution. As shown in FIG. 1, the receptacle 10 may also be used for the simultaneous cleaning of a toilet brush 22. The head of the toilet brush 22 and the bell 20 of the plunger are immersed within a sanitizing solution held within tank 12. The sanitizing solution disinfects the toilet implements, and brushes 24 and 26, described in further detail below, provide for removal of solid waste from the plunger through abrasion. Used sanitizing solution may be drained through drainage hole 30, with the flow being regulated and controlled by a user through operation of a valve or faucet 32.

Tank 12 includes a lower surface 40 having a lower brush 26 mounted to an interior surface thereof and projecting upwardly therefrom, to fit within the interior of plunger bell 20. The preferred positioning of the brush 26 can be seen in FIGS. 1 and 2. It should be understood that brushes 24 and 26 may be mounted in any suitable position within tank 12. Upper brush 24 is mounted on an interior surface of sidewall 42 and is positioned adjacent the lower brush 26. As shown in FIG. 1, upper brush 24 extends horizontally to contact the exterior of toilet plunger bell 20 and is fixed to at least one point on the interior of tank 12. In FIG. 1, brush 24 is shown as being fixed at two ends, with each end being positioned on a respective adjacent sidewall, although brush 24 may, alternatively, include a free end contacting bell 20.

As shown in FIG. 1, when the toilet plunger is inserted within tank 12 for cleaning, the interior of bell 20 contacts lower brush 26 and the exterior of bell 20 contacts upper brush 24. Rotation of handle 18 causes bell 20 to spin between brushes 26 and 24, thus providing abrasive cleaning action in addition to the disinfectant effect of the cleaning solution. The plunger handle 18 is held and secured within opening 34, which is sized and shaped to receive the plunger handle 18 and provide for free rotation of the handle 18 therein.

A pair of doors 14, 16 are pivotally secured to an upper end of receptacle tank 12 by hinges. Door 16 has plunger hole 34 formed therethrough for receiving and securing plunger handle 18. Similarly, door 14 has a brush hole 36 formed therethrough for receiving and securing the handle of toilet brush 22. Each door 14, 16 has a handle 38 attached to an upper surface thereof, allowing for the easy opening and closing of doors 14, 16. Although FIGS. 1 and 2 illustrate door 16 having a longer longitudinal length than that of door 14, the doors may have any relative length, so long as the combined length covers the top of the tank 12.

The lower surface 40 of tank 12 has a drainage hole 30 formed therethrough with a faucet 32 controlling flow of sanitizing solution through the hole 30. Following disinfection of the toilet cleaning implements, the used sanitizing solution may be drained off and collected in a receptacle placed under system 10, or connected to any other suitable drainage receptacle, such as a bathroom sink.

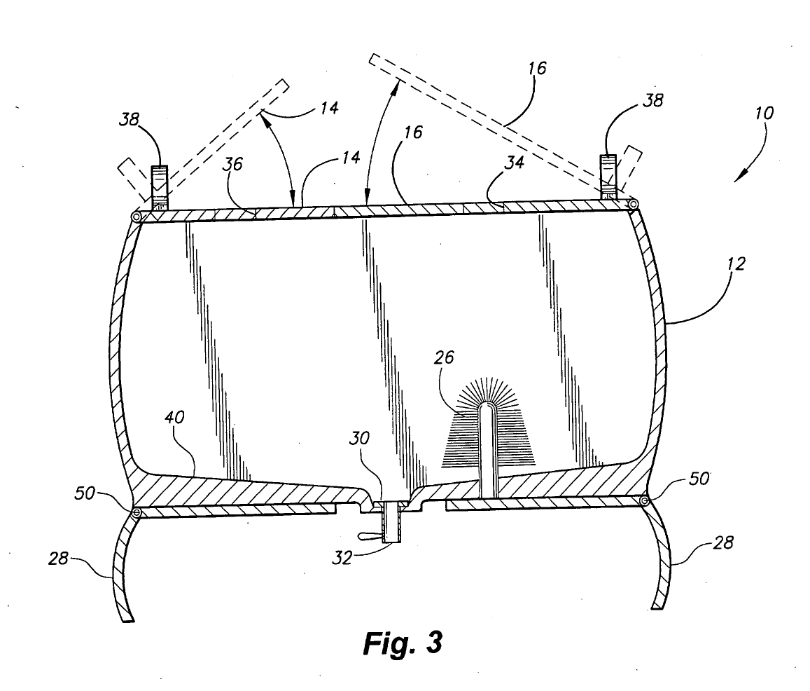

Further, a pair of legs 28 are secured to a lower end of tank 12, forming a stand for the receptacle 10. As shown in the alternative embodiment of FIG. 3, legs 28 may be pivotally retracted beneath the tank 12 through the addition of pivotal mounting elements, such as hinges 50, and may lock into an extended position. In the embodiment of FIGS. 1 and 2, the legs 28 are fixed in their extended positions without the use of hinges 50 and are, thus, nonretractable. Receptacle 10 may be mounted on any suitable surface, such as the bathroom floor, on top of the toilet, or positioned over the sink. The receptacle 10 is portable and may be positioned in any suitable environment selected by the user.

In the alternative embodiment of FIG. 3, the upper brush 24 has been removed. In the embodiment of FIG. 3, the toilet plunger 18 is cleaned solely through immersion of the bell portion 20 within the sanitizing solution, and further through rotation of the bell portion 20 about the lower brush 26.

In operation, tank 12 is filled with a sanitizing solution in order to clean and disinfect the toilet plunger and toilet brush 22. The sanitizing solution may be poured into tank 12 through the opening of doors 14, 16, or an inlet 44 may be provided through an upper sidewall of tank 12, as shown in FIG. 1. Sanitizing solution may be poured directly through inlet 44, or a separate hose or other insertion means may be provided for external connection to inlet 44.

Plunger handle 18 is inserted through plunger hole 34 and the handle of toilet brush 22 is inserted through hole 36. Doors 14 and 16 are closed, so as to immerse the brush and plunger within the sanitizing solution and also position bell 20 between brushes 24 and 26. Handle 18 is rotated to abrade the interior and exterior surfaces of bell 20 against the respective brushes 24, 26. Once clean, the user opens faucet 32 to drain the sanitizing solution through drainage hole 30.

It is to be understood that the present invention is not limited to the embodiments described above, but encompasses any and all embodiments within the scope of the following claims.

We claim:

1. A toilet plunger cleaning receptacle, comprising:
a receptacle tank dimensioned and configured for receiving a toilet plunger and a volume of sanitizing solution, the tank having a lower surface and at least one sidewall extending from the lower surface to define an open upper end;
at least one door pivotally mounted on the upper end of the receptacle tank, the at least one door selectively sealing the open upper end of the receptacle tank, the at least one door having a plunger hole formed therethrough dimensioned and configured for receiving a handle of the plunger;
a lower brush disposed within the tank and attached to the lower surface of the receptacle tank, the lower surface of the receptacle tank having a drainage hole formed therethrough;
an upper brush disposed within the tank and attached to the at least one sidewall of the receptacle tank, the upper brush being positioned adjacent the lower brush; and
a faucet extending from the drainage hole for controlling drainage of the sanitizing solution through the drainage hole;
whereby, the toilet plunger is inserted into the receptacle tank with the plunger handle projecting through the plunger hole, an interior surface of a bell of the toilet plunger contacting the lower brush and an exterior surface of the bell contacting the upper brush, the receptacle being filled with the sanitizing solution in order to clean the bell when the plunger handle is rotated.

2. The toilet plunger cleaning receptacle as recited in claim 1, further comprising a plurality of legs are mounted to the lower surface of said receptacle tank.

3. The toilet plunger cleaning receptacle as recited in claim 2, wherein said plurality of legs are pivotally mounted to the lower surface of said receptacle tank.

4. The toilet plunger cleaning receptacle as recited in claim 1, wherein further comprising a handle attached to said at least one door.

5. The toilet plunger cleaning receptacle as recited in claim 1, wherein said at least one door comprises:
a plunger door having said plunger hole formed therethrough; and
a brush door having a brush hole formed therethrough dimensioned and configured for receiving a handle of a toilet brush.

6. The toilet plunger cleaning receptacle as recited in claim 1, wherein said tank has an inlet formed therein adapted for filling said receptacle tank with the sanitizing solution.

7. A toilet plunger cleaning receptacle comprising:
a receptacle tank dimensioned and configured for receiving a toilet plunger and a volume of sanitizing solution, the tank having a lower surface and at least one sidewall extending from the lower surface to define an open upper end;
at least one door pivotally mounted on the upper end of the receptacle tank, the at least one door selectively sealing the open upper end of the receptacle tank, the at least one door having a plunger hole formed therethrough dimensioned and configured for receiving a handle of the plunger;
a lower brush disposed within the tank and attached to the lower surface of the receptacle tank, the lower surface of the receptacle tank having a drainage hole formed therethrough; and
a faucet extending from the drainage hole for controlling drainage of the sanitizing solution through the drainage hole;
whereby the toilet plunger is inserted into the receptacle tank with the plunger handle projecting through the plunger hole, an interior surface of a bell of the toilet plunger contacting the lower brush, the receptacle being filled with the sanitizing solution in order to clean the bell when the plunger handle is rotated.

8. The toilet plunger cleaning receptacle as recited in claim 7, further comprising an upper brush attached to the at least one sidewall of the receptacle tank within the tank, the upper brush being positioned adjacent said lower brush, whereby the upper brush abrasively cleans an exterior surface of the bell.

9. The toilet plunger cleaning receptacle as recited in claim 7, further comprising a plurality of legs mounted to the lower surface of said tank.

10. The toilet plunger cleaning receptacle as recited in claim 9, wherein said legs are pivotally mounted to the lower surface of said tank.

11. The toilet plunger cleaning receptacle as recited in claim 7, wherein further comprising a handle attached to said at least one door.

12. The toilet plunger cleaning receptacle as recited in claim 7, wherein said at least one door comprises:
a plunger door having the plunger hole formed therethrough; and
a brush door having a brush hole formed therethrough dimensioned and configured for receiving a handle of a toilet brush.

13. The toilet plunger cleaning receptacle as recited in claim 7, wherein said tank has an inlet formed therein adapted for filling said receptacle tank with the sanitizing solution.

14. The toilet plunger cleaning receptacle as recited in claim 7, wherein the drainage hole is positioned substantially centrally through the lower surface of said tank.

15. The toilet plunger cleaning receptacle as recited in claim 14, wherein the lower surface of said tank is angled with respect to horizontal on either side of the drainage hole, whereby the sanitizing solution flows towards the drainage hole by gravity.
